(19) United States
(12) Patent Application Publication
(10) Pub. No.: US 2026/0245969 A1
(43) Pub. Date: Aug. 20, 2026

(54) LASER PATTERNED SOLID-STATE BATTERIES, AND METHODS OF MAKING AND USING THE SAME

(71) Applicant: Ensurge Micropower ASA, Oslo (NO)

(72) Inventors: Richard VAN DER LINDE, San Jose, CA (US); Hui YANG, Columbia, SC (US); Alex YAN, San Jose, CA (US); Arvind KAMATH, Los Altos, CA (US)

(73) Assignee: Ensurge Micropower ASA, Oslo (NO)

(21) Appl. No.: 19/452,175

(22) Filed: Jan. 16, 2026

Related U.S. Application Data
(60) Provisional application No. 63/760,587, filed on Feb. 19, 2025.

(51) Int. Cl. H01M 10/0585; H01M 4/66; H01M 4/82; H01M 10/052; H01M 10/0562; H01M 10/658; H01M 4/02

(52) U.S. Cl. CPC H01M 10/0585; H01M 4/663; H01M 4/82; H01M 10/052; H01M 10/0562; H01M 10/658; H01M 2004/021; H01M 2004/027; H01M 2004/028; H01M 2300/0077

(57) ABSTRACT

Solid-state battery cells and a method of making solid-state battery cells are disclosed. The method includes laser-patterning a cathode layer on a substrate to form a cathode for each cell, forming an insulator between cathodes that exposes an uppermost surface of each cathode, blanket-depositing a solid-state electrolyte layer on the cathodes and the insulator, blanket-depositing an anode current collector (ACC) layer on the electrolyte layer, and patterning the ACC layer and the electrolyte layer to form an electrolyte and an ACC in each cell. The cell includes a substrate, a cathode having sidewalls at an angle of 5-75°, an insulator surrounding a base of the cathode, a solid-state electrolyte on the cathode, an ACC on the electrolyte, an encapsulant on the ACC and the insulator, an insulator layer along one sidewall of the cell, and a redistribution layer on the encapsulant and the insulator layer, electrically contacting the ACC.

### CROSS-REFERENCE TO RELATED APPLICATIONS

This application claims the benefit of U.S. Provisional Pat. Appl. No. 63/760,587, filed February 19, 2025, pending, incorporated herein by reference in its entirety.

### FIELD OF THE INVENTION

The present invention generally relates to the field of solid-state and/or thin film batteries. More specifically, embodiments of the present invention pertain to laser-patterned solid-state batteries (i.e., containing one or more laser-patterned layers), and methods of making and using the same.

### DISCUSSION OF THE BACKGROUND

Solid-state lithium batteries are ionic-charge storage devices that are ideally suited for wearable, IoT, and other applications due to their small size, safety, and high cyclability. In an “anode-less” architecture, a solid-state lithium battery is a multi-layer structure consisting of a cathode current collector (CCC), a cathode, a solid-state electrolyte, and an anode current collector (ACC). While the ACC is electrically separated from the CCC by the solid-state electrolyte, it usually has a smaller area or pattern than the CCC to avoid ACC-to-CCC shorting when cells are cut from a larger substrate (e.g., a roll or sheet).

Roll-to-roll (R2R) manufacturing of solid-state batteries is ideally suited for blanket depositions of the individual layers of the batteries. However, patterning of certain layers allows for better control of lithium containment and better encapsulation.

Masking during R2R manufacturing has a number of challenges, including maintaining direct contact of the mask (e.g., a shadow mask) during deposition, and the necessity for a new mask (or for cleaning the mask) after every deposition. The latter challenge increases cost and complexity of patterning solid-state battery layers in an R2R manufacturing process.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to solid-state and thin film batteries, and more specifically to a laser-patterned solid-state battery and methods of making the same. The present invention avoids the issues in the background art by forming a laser-patterned cathode (e.g., patterning a blanket-deposited cathode layer by laser patterning and/or laser ablation) and an insulator in the space(s) between adjacent patterned cathodes. Besides achieving a dry, high-fidelity pattern, this approach is also advantageous for patterning flexibility, better sealing of the cell, and lower cost and higher throughput, since the laser ablation pattern and process does not involve fabricating a physical mask (e.g., a photolithography or shadow mask). Some embodiments provide the laser-patterned cathode with sloped sidewalls, which facilitates subsequent processing and reduces stress in overlying materials, as well as from differential expansion or contraction of the various materials in the solid-state battery cells. The insulator further enables damage-free laser patterning of the anode current collector and electrolyte layers, which in turn avoids the lithium migration and loss that occurs during plasma-assisted etching (as part of a photolithographic patterning process).

Thus, in one aspect, the invention relates to a method of making solid-state battery cells, comprising laser-patterning a cathode layer on a substrate to form a cathode for each of a plurality of solid-state battery cells, forming an insulator between cathodes in adjacent cells, exposing an uppermost surface of the cathode in each solid-state battery cell, blanket-depositing a solid-state electrolyte layer on the cathodes and the insulator, blanket-depositing an anode current collector (ACC) layer on the solid-state electrolyte layer, wherein the solid-state electrolyte layer contacts the exposed uppermost surface of the cathode in each solid-state battery cell, and patterning the ACC layer and the electrolyte layer to form an electrolyte and an ACC in each of the cells, thereby defining the solid-state battery cells. In some embodiments, laser patterning provides the cathodes with sloped sidewalls (e.g., having an angle of 5-75° relative to the plane of the substrate). The insulator may be formed by selective deposition (e.g., printing), or by blanket-deposition (e.g., by chemical vapor deposition [CVD] or sol-gel processing) and photolithographic patterning or polishing. In some embodiments, the ACC layer and the electrolyte layer may be patterned by laser patterning or laser ablation, optionally substantially simultaneously (e.g., in the same laser patterning or laser ablation operation).

In some embodiments of the method, the cathode layer is laser-patterned using a programmable laser patterning device. In such embodiments, the method may further comprise programming the programmable laser patterning device. For example, the programmable laser patterning device may be programmed to form polylines (with sloped sidewalls or sidewalls substantially at right angles to the substrate) in the cathode layer. The polylines may comprise a first plurality of parallel lines along a first direction and a second plurality of parallel lines along a second direction. For example, the second direction may be orthogonal to the first direction. However, the first and second pluralities of parallel lines may not form sharp corners. In other or further examples, the first and second pluralities of parallel lines may have a width of 5-50 μm, independent of each other (individually or as one of the pluralities, in which each of the first plurality of parallel lines has a first width, and each of the second plurality of parallel lines has a second width independent of the first width). The method may also further comprise cleaning the laser-patterned cathodes prior to forming the insulator and/or laser-patterning the ACC layer and the electrolyte layer using the same or a similar programmable laser patterning device programmed to form second polylines in the ACC layer and the electrolyte layer in a similar or identical pattern as the first polylines in the cathode layer, but where the second polylines may be wider than the first polylines.

In various embodiments, the insulator may comprise a silicon oxide (e.g., undoped silicon dioxide, silicon dioxide doped with one or more dopants selected from boron, phosphorous and/or carbon, a silicon oxynitride, etc.) or a heat-tolerant organic polymer (e.g., parylene, a polyester, a polyamide or polyimide, etc.).

In various embodiments, blanket-depositing a material may comprise depositing the material (e.g., by sputtering, chemical vapor deposition [CVD], atomic layer deposition [ALD], sol-gel processing, etc.) in a uniform or substantially uniform thickness. In other embodiments, selectively depositing a material may comprise printing (e.g., screen printing, inkjet printing, etc.) or sputtering / evaporation through a shadow mask.

The method may further comprise encapsulating the battery cells with an encapsulant, forming a via or opening in the encapsulant in each cell (e.g., to expose the ACC), cutting or dicing the cells through the encapsulant, the insulator and the substrate (e.g., every other cell, or every other column or row of cells, by laser dicing, mechanical dicing or stamping) to expose an ACC edge or sidewall of the cells, forming an insulator layer along the ACC edge or sidewall, and forming a redistribution layer in or over the via or opening (e.g., in electrical contact with the ACC) and on the insulator layer along the ACC edge or sidewall. In such embodiments, cutting or dicing the battery cells may form dual cells or dual rows or columns of cells. In some such embodiments, encapsulating each of the battery cells may comprise inkjet printing or screen printing the encapsulant onto the battery cells in a pattern including the openings or vias. Alternatively, encapsulating the battery cells may comprise coating or blanket-depositing the encapsulant onto the battery cells, and patterning the coated or blanket-deposited encapsulant (e.g., photolithographically) to form the openings or vias.

Typically, the encapsulant comprises a moisture barrier and/or electrical insulation film. For example, the encapsulant may comprise a polyolefin (which may be moisture-repellant or moisture-resistant), such as a parylene. In various embodiments, the redistribution layer comprises an elemental metal or an alloy thereof (e.g., an alloy consisting essentially of elemental metals), and may be formed by sputtering, atomic layer deposition (ALD) or thermal evaporation, followed by photolithographic patterning and etching. Alternatively, the redistribution layer may be formed by selective deposition, such as inkjet printing, aerosol-jet printing or screen printing. In certain embodiments, the redistribution layer has a thickness of 0.25-2.0 μm.

The method may further comprise singulating the solid-state battery cells. For example, the encapsulated battery cells (e.g., the dual cells or dual rows or columns of cells) with the redistribution layer thereon may be singulated by cutting or dicing the cells through the encapsulant, the insulator and the substrate to form a cathode current collector (CCC) contact in each of the solid-state battery cells, and the singulated battery cells may be packaged to form a solid-state battery. The method may further comprise stacking the singulated battery cells prior to packaging. The battery cells may be stacked so that all of the ACC edges or sidewalls are on a first side of the stacked battery cells, and all of the CCC contacts are on a second (e.g., opposite) side of the stacked battery cells.

In some embodiments, stacking the singulated battery cells comprises depositing an adhesive (e.g., an epoxy adhesive) on a first one of the singulated battery cells, and placing a next one of the singulated battery cells on the first one of the singulated battery cells. Optionally, the method may further comprise stacking one or more of the singulated battery cells on the next one of the singulated battery cells until a last one of the singulated battery cells is stacked. In other or further embodiments, stacking the singulated battery cells further comprises placing a dummy cell on the last one of the singulated battery cells. In various embodiments, placing the next one of the singulated battery cells on the first one of the singulated battery cells comprises a pick-and-place operation. In other embodiments, when the singulated battery cells comprise a row or column of cells, stacking the singulated battery cells may comprise strip folding or strip stacking the row or column of cells.

In some embodiments, the cathode layer comprises a lithium metal oxide or lithium metal phosphate, such as lithium cobalt oxide (LCO), lithium manganese oxide (LMO), or lithium iron phosphate (LFP). In other or further embodiments, the method may further comprise blanket-depositing a cathode material onto the substrate by laser deposition, sputtering, chemical vapor deposition (CVD), sol-gel processing, screen printing, inkjet printing, spray coating, or extrusion coating to form the cathode layer. In such embodiments or different embodiments, the substrate may comprise a metal foil, and the method may further comprise forming a diffusion barrier on one or both major surfaces of the metal foil (e.g., prior to blanket-depositing the cathode layer or otherwise forming the cathode layer on the substrate, or more particularly, on the diffusion barrier).

In some embodiments, the solid-state electrolyte comprises lithium phosphorus oxynitride (LiPON), carbon-doped LiPON, Li₂WO₄, or one or more layers of a lithium lanthanum zirconium oxide (LLZO), in which some of the Zr may be substituted with one or more of niobium, tantalum, aluminum, gallium, indium, vanadium, antimony or hafnium. In other or further embodiments, blanket-depositing the solid-state electrolyte comprises depositing a LiPON layer or a tungsten oxide layer of the formula WO₃₊ₓ (0 ≤ x ≤ 1) by sputtering or atomic layer deposition (ALD), or depositing one or more LLZO layers by sol-gel techniques. When blanket-depositing the solid-state electrolyte comprises depositing the tungsten oxide layer, blanket-depositing the solid-state electrolyte may comprise sputtering using a metallic or elemental tungsten target in an oxygen-containing atmosphere to form the tungsten oxide layer, then lithiating and thermally annealing the tungsten oxide layer. In some embodiments, the method further comprises forming an interface material comprising a lithiated metal oxide on the cathode material and/or the solid-state electrolyte.

In some embodiments, the ACC layer comprises a conductive metal, such as nickel, zinc, copper, tungsten, vanadium, an alloy of one or more of these metals, or graphite. When the ACC layer is the conductive metal, the conductive metal should be incapable of forming an alloy with lithium. The ACC material may be deposited by spray coating, sputtering, evaporation, CVD or ALD, and may have a thickness of 0.1-5 µm.

In some embodiments, the substrate comprises a metal foil. For example, the metal foil may function as a cathode current collector in each of the battery cells. In such embodiments, the method may further comprise forming a diffusion barrier on one or both major surfaces of the metal foil prior to blanket-depositing the cathode material. In various examples, the metal foil comprises elemental aluminum, copper, titanium, nickel, iron, or an alloy thereof (e.g., stainless steel). For example, the metal foil may have a thickness of 10-100 μm. In embodiments including the diffusion barrier, the method may further comprise depositing an insulation layer such as a silicon oxide on the diffusion barrier. Thus, in some embodiments, the diffusion barrier may comprise a metal nitride or a combination of the metal nitride and a silicon oxide (e.g., alternating metal nitride diffusion barrier and silicon oxide insulation layers).

In another aspect, the invention relates to a solid-state battery cell, comprising a cathode, an insulator surrounding a base of the cathode, a solid-state electrolyte on the cathode, an anode current collector (ACC) on the solid-state electrolyte, an encapsulant on the ACC and the insulator, an insulator layer along an ACC sidewall of the battery cell, and a redistribution layer on the encapsulant and the insulator layer, in electrical contact with the ACC. The electrolyte and the ACC are generally co-extensive (i.e., they have substantially the same width and substantially the same length, and their sidewalls are aligned and/or have substantially the same slope). The cathode may have sloped sidewalls (e.g., at an angle of 5-75° with respect to the substrate). The sidewalls of the electrolyte and the ACC may be separated from the cathode by the insulator. In embodiments including a cathode current collector (CCC) having a CCC contact, the insulator and the encapsulant are along an outermost periphery of the solid-state battery cell above the CCC contact.

Compared to a photolithographically-patterned cathode having otherwise identical properties and characteristics, the laser-patterned cathode has peripheral edges or sidewalls with a greater variance (e.g., from linearity and/or planarity). Compared to a printed cathode having otherwise identical properties and characteristics, the laser-patterned cathode has greater purity and/or better electrical properties. The present solid-state battery cell may further comprise any of the other structures and materials described herein.

Other capabilities and advantages of the present invention will become readily apparent from the detailed description of various embodiments below.

### BRIEF DESCRIPTION OF THE DRAWINGS

FIG. 1 is a cross-sectional view of an exemplary substrate suitable for use in an exemplary method of making solid-state battery cells, according to embodiments of the present invention.

FIG. 2 is a cross-sectional view of the exemplary substrate of FIG. 1 with an exemplary cathode layer thereon, in accordance with embodiments of the present invention.

FIGS. 3A-B are cross-sectional and layout (top-down) views, respectively, of the exemplary structure of FIG. 2 after laser patterning, according to one or more embodiments of the present invention.

FIG. 4 is a cross-sectional view of the exemplary structure of FIG. 3A with an exemplary insulator between and surrounding the base of the laser-patterned cathodes, in accordance with one or more embodiments of the present invention.

FIGS. 5-7 are cross-sectional views of various structures in an exemplary method of making solid-state battery cells, according to embodiments of the present invention.

FIGS. 8A-B are cross-sectional and layout views, respectively, of the exemplary structure of FIG. 7 after via formation and cutting or dicing to form ACC sidewalls in the exemplary method of making solid-state battery cells, according to embodiments of the present invention.

FIGS. 9-10 are cross-sectional views of structures in the exemplary method of making solid-state battery cells during insulator layer formation along the ACC sidewalls, according to one or more embodiments of the present invention.

FIGS. 11A-B are cross-sectional and layout views, respectively, of the exemplary structure of FIG. 10 following formation of a redistribution layer (RDL) in the exemplary method of making solid-state battery cells, according to embodiments of the present invention.

FIGS. 12A-B are cross-sectional and layout views, respectively, of the exemplary structures of FIGS. 11A-B following singulation, according to embodiments of the present invention.

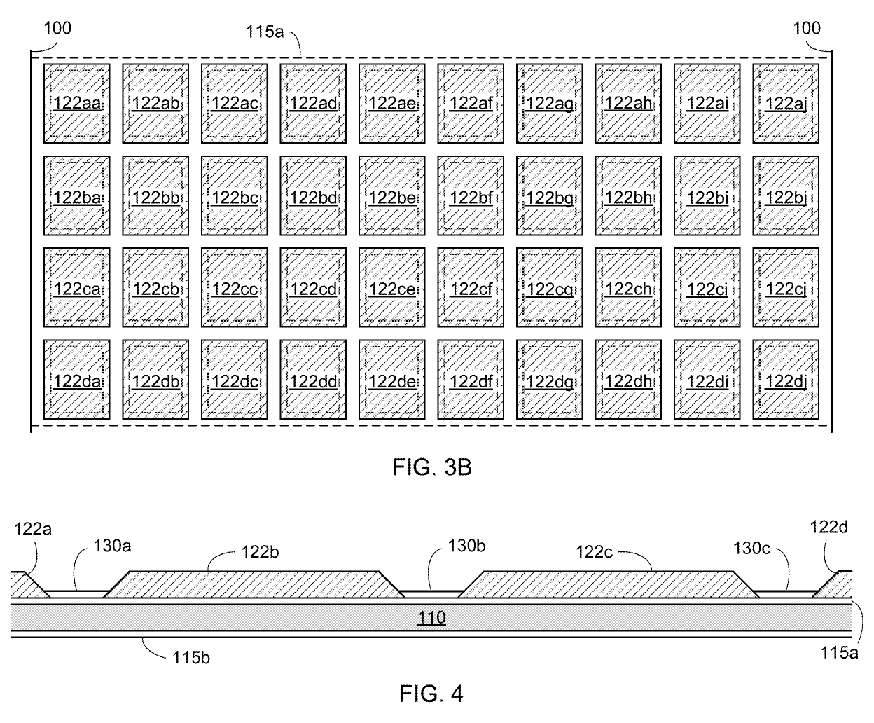

The layout (top-down) views of FIGS. 3B, 8B, 11B and 12B are the structures shown in FIGS. 3A, 8A, 11A and 12A, but zoomed out to show a larger structure.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present invention concerns a solid-state battery cell containing a laser-patterned cathode, an insulator surrounding the base of the cathodes and facilitating subsequent laser-patterning of additional layers of the solid-state battery cell, and methods of making the same. The present solid-state battery cell includes, in some embodiments, an intrinsic anode-less battery cell comprising a substrate (which can also serve or function as a cathode current collector [CCC]), the laser-patterned cathode, a solid-state electrolyte (SSE), an anode current collector (ACC), and an encapsulant on the ACC and the insulator, sealing the solid-state battery cell from ingress of external contaminants (e.g., air and water). The solid-state battery cell may further comprise an insulator layer along at least one sidewall of the cell, and a redistribution layer in electrical contact with the ACC (e.g., through an opening or via in the encapsulant) and on the insulator layer along the sidewall of the cell. In anode-less embodiments, no lithium anode is formed between the SSE and the ACC during manufacturing. A lithium anode may form during or upon completion of a battery charging operation.

The following discussion provides an example of a manufacturing process for solid-state batteries including a laser-patterned cathode and stacked solid-state batteries, as well as variations of the process.

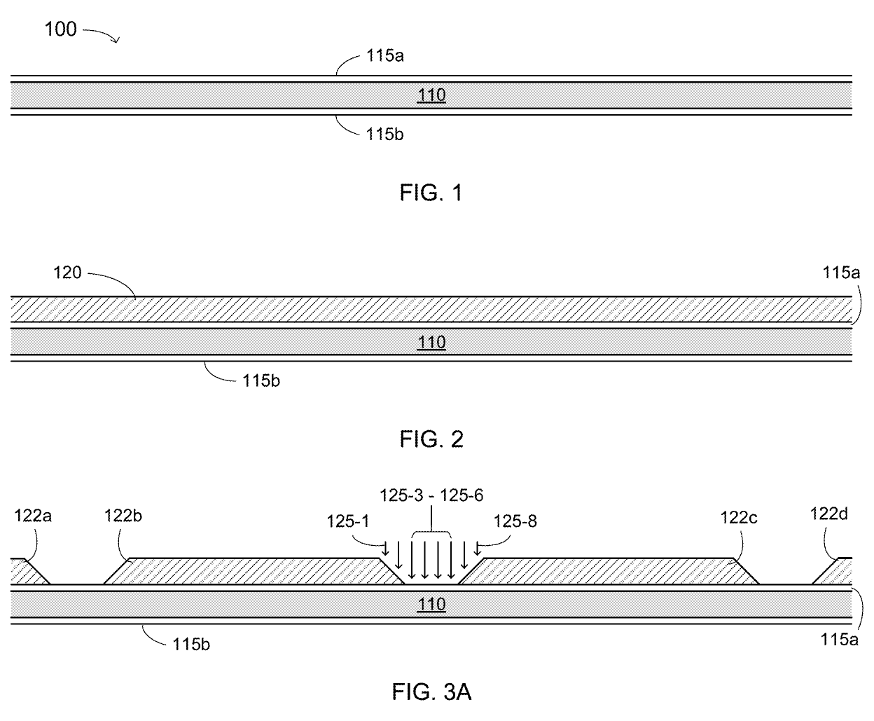

FIG. 1 shows a substrate 100, comprising a metal foil, sheet or film 110 and optional first and second barriers 115a-b on opposite major surfaces of the metal foil, sheet or film 110. When the foil, sheet or film 110 is a metal foil, the first barrier 115a is not optional. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, electrical conductivity, resistance to corrosion or chemical attack during subsequent processing, etc.). However, the substrate 110 can also be a metal sheet or a roll of metal foil. For example, the foil or film may be 10-100 µm thick, whereas a metal sheet may have a thickness of > 100 µm, up to about 1-2 mm, although the invention is not so limited. Other alternative substrates include a metal coating on a mechanical substrate, such as aluminum, copper, nickel, titanium, etc., on a removable plastic film, sheet or roll.

The barriers 115a-b generally comprise one or more layers of one or more materials in a thickness effective to prevent migration of atoms or ions from the metal foil, sheet or film 110 into overlying (or underlying) layers. The barrier material(s) may comprise a glass or ceramic, such as silicon dioxide, aluminum oxide, silicon nitride, a silicon and/or aluminum oxynitride, etc., or a (refractory) metal nitride, such as aluminum nitride, titanium nitride, titanium aluminum nitride, tungsten nitride, titanium tungsten nitride, a TiW alloy, tantalum nitride, etc. In some embodiments, each of the first and second barriers 115a-b comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier 115a or 115b may have a total thickness of 0.05-3 µm, but the barrier 115a-b is not limited to this range. The barriers 115a-b may be blanket-deposited onto the foil, sheet or film 110 by chemical or physical vapor deposition (e.g., sputtering, thermal evaporation, atomic layer deposition [ALD], etc.), solution-phase coating with a precursor material followed by annealing to form the glass/ceramic or metal nitride, etc. Exemplary barrier materials, structures and thicknesses and methods for their deposition are disclosed in U.S. Pat. Nos. 9,299,845 and 11,742,363, the relevant portions of each of which are incorporated by reference herein.

In some embodiments, the foil, sheet or film 110 functions as a cathode current collector. In such embodiments, at least the barrier 115a (and optionally the barrier 115b) is or includes a conductive, amorphous material, such as the refractory metal nitrides listed above or an amorphous metal alloy (e.g., a TiW alloy).

FIG. 2 shows the metal substrate 100 with a cathode layer 120 thereon. The cathode layer 120 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode layer 120 may be blanket deposited by laser deposition (e.g., pulsed laser deposition or PLD), sputtering, chemical vapor deposition (CVD), sol-gel processing (e.g., spin-coating or drip coating a sol or gel containing one or more cathode material precursors), spray coating, or extrusion coating (e.g., using an ink comprising one or more sol-gel precursors and one or more solvents, having a viscosity appropriate for the printing or coating technique), etc. After deposition, the cathode layer 120 may be annealed (e.g., at a temperature of 500-800 °C, or any temperature or range of temperatures therein) for a length of time sufficient to achieve a predetermined or desired crystalline structure.

Alternatively, the cathode layer 120 (typically in combination with the substrate 100) may comprise a lithium metal oxide or lithium metal phosphate ceramic sheet. Such ceramic sheets may be on a backing material (e.g., a polymeric tape), and thus be transferable, and may have a width similar or identical to a sheet or roll of the substrate 110. Such lithium metal oxide and lithium metal phosphate ceramic sheets may have a thickness of 15-50 μm, or any value or range of values therein. and are commercially available from NEI Corporation (Somerset, NJ), Targray (Kirkland, Canada), and MSE Supplies (Tucson, AZ). The sheet may be adhered to the substrate 110 using a thin layer (e.g., 300 Å – 2 μm) of an elemental metal, such as aluminum or titanium, or an electrically conductive alloy, such as a conventional tin solder. Thus, the present method may further comprise blanket-depositing an elemental metal or an electrically conductive alloy onto the substrate 100, then placing (and optionally pressing, with further optional application of heat) the cathode layer 120 onto the elemental metal or electrically conductive alloy.

FIGS. 3A-B show the cathode layer 120 of FIG. 2 after laser patterning to form discrete cathodes 122a-d (FIG. 3A) or an array of cathodes 122aa-dj (FIG. 3B). In various embodiments, the material of the cathode layer 120 is laser-patterned using light having a wavelength of 240-1400 nm, a pulse length of 5 femtoseconds to 1000 ns, a pulse frequency of 10⁵-10¹⁴ Hz, and/or a power of 10-1000 W. For example, an LCO cathode layer 120 may be ablated using a laser emitting infrared light (e.g., 980-1090 nm, or any wavelength or wavelength band therein) with a pulse length of 300-1000 fs (or any pulse length or range of pulse lengths therein) and a pulse frequency of 1-5 MHz (or any frequency or range of frequencies therein), at a power of 1-10 W (or any power or range of powers therein) and a dose of 25-75% (or any percentage or range of percentages therein).

In some embodiments, the cathode layer 120 is laser-patterned using a programmable laser patterning device. In such embodiments, the method may further comprise programming the programmable laser patterning device. For example, the programmable laser patterning device may be programmed to form polylines in the cathode layer 120, and may result in the cathodes 122a-d or 122aa-dj having either sloped sidewalls or sidewalls substantially at right angles to the plane of the substrate 100. The polylines may comprise a first plurality of parallel lines along a first direction and a second plurality of parallel lines along a second direction, and the second direction may be orthogonal to the first direction. However, in addition to the sloped sidewalls, the first and second pluralities of parallel lines may not form sharp corners on the cathodes 122a-d or 122aa-dj.

In some examples, the first and second pluralities of parallel lines may have a width of 5-50 μm at the interface between the cathodes 122a-d or 122aa-dj and the first barrier 115a, independent of each other (individually or as one of the pluralities, in which each of the first plurality of parallel lines has a first width, and each of the second plurality of parallel lines has a second width independent of the first width). The surface of the cathodes 122a-d and 122aa-dj at this interface and a portion of the cathodes 122a-d and 122aa-dj adjacent to these surfaces may be referred to as the bases of the cathodes 122a-d and 122aa-dj. Depending on the techniques to be used to pattern subsequent layers of the battery cells and to cut, dice or singulate the cells, as well as the variability in those techniques, the spacing between the cathodes 122a-d and 122aa-dj at the first barrier 115a (and thus the widths of the first and second pluralities of parallel lines) may be in the range of 10-50 μm, or any value or range of values therein (e.g., 20-30 μm).

Typically, an ablation pattern (e.g., a graphical drawing representing the areas of the blanket-deposited cathode layer 120 to be removed) is created and run on the programmable laser patterning device. The drawing may consist of a series of polylines (e.g., a first plurality of parallel lines spaced apart by a first distance, and a second plurality of parallel lines orthogonal to the first plurality of parallel lines and spaced apart by a second distance the same as or different from the first distance) at an optimized spacing to form cleanly ablated regions outside of the desired remaining pattern of cathodes 122a-d and 122aa-dj. Depending on parameters and conditions of deposition of the cathode layer 120, additional lines along the periphery of the sheet or roll 100 may also be laser-patterned, at least in part to ensure pull-back of the patterned cathodes 122aa, 122aj, 122ba, 122bj, 122ca, 122cj, 122da and 122dj from the edge of the sheet or roll and/or to ensure that the patterned ACCs 122aa, 122ah, 122ba, 122bh, 122ca, 122cj, 122da and 122dj have a desired or predetermined sidewall slope along the edge of the sheet or roll 100.

In a representative example, the graphical drawing is in a format used by laser patterning or ablation tools, such as an Autocad.dxf or .dwg file. The graphical drawing comprises or consists of a series of polylines having a width that may be optimized for a given laser tool. In some embodiments, the polylines exclude sharp corners (e.g., angles between crossing, consecutive or adjacent lines that have an angle therebetween of 90° or less), to reduce or minimize electric field concentration at such corners, which may adversely affect battery cycling and/or battery lifetimes. Thus, laser patterning the cathode layer 120 enables corner rounding of the cathodes 122aa-dj in each cell. Because there is no need for a mask, the ultimate shape of the cathodes 122a-d (FIG. 3A) and 122aa-dj (FIG. 3B) is somewhat arbitrary, and can be any shape that can be formed using a conventional laser patterning or laser ablation tool.

The laser beam profile is typically gaussian or top hat, depending on the target profile for material removal. The line widths (i.e., spacing between cathodes 122a-d and 122aa-dj) also depend on the laser beam spot size and energy profile, in addition to the desired separation between adjacent cathodes 122a-d and 122aa-dj for subsequent processing. For example, the full width at half-maximum power (or half-power beam width) of the laser beam may be in the range of 2-50 µm, but it can be adjusted (increased or decreased) using focusing lenses.

In embodiments in which the cathodes 122a-d and 122aa-dj have sloped sidewalls (e.g., as shown in FIG. 3A), the sidewalls may have an angle of 5-75° (or any angle or range of angles therein) with respect to the plane of the substrate 100. In various examples, the angle may be in the range of 10-45°. The sloped sidewalls advantageously reduce the stress in overlying layers, as well as the stress from differential thermal expansion or contraction of the different materials during processing and use. One way to produce the sloped sidewalls is to partially ablate a relatively wide line, then ablate another part of a slightly smaller line contained within the relatively wide line, and so on until the smallest line completes ablation of the cathode layer 120. This can also be one with repeated ablations of adjacent or overlapping lines of relatively small width.

For example, referring to FIG. 3A, a first line 125-1 may be ablated at a dose and/or power removing a part (e.g., 20-40%) of the cathode layer 120. A second line 125-2 immediately adjacent to the first line 125-1 may be ablated twice at the dose and/or power that removes the part of the cathode layer 120. Thus, two parts (e.g., 40-80%) of the cathode layer 120 are removed in the second line 125-2. A plurality of third lines 125-3 through 125-6 may be ablated at three or more times at the dose and/or power that removes the part of the cathode layer 120, depending on the percentage of the cathode layer 120 removed in the first line 125-1. The number of third lines 125-3 through 125-6 may depend on a desired or target spacing between adjacent cathodes 122a-d. Additional lines between the first and second lines 125-1 and 125-2 and/or between the second and third lines 125-2 and 125-3 may be similarly ablated, where each line towards the gap between adjacent cathodes 122a-d is ablated one more time than the adjacent line higher on the sidewall slope. Lines 125-7 and 125-8 for ablating the opposing sidewall (e.g., of cathode 122c, facing cathode 122b) are a mirror image of the first and second lines 125-1 and 125-2. The angle of the sidewall slope may be varied by varying the number of lines, the gap between each line in a group of lines defining the sidewall slope, and/or the dose of radiation and/or the power of the laser.

The laser power and scan parameters may be optimized for a given laser wavelength, ablation depth, and cathode sidewall slope. For example, the laser wavelength may range from infrared or red (e.g., 800-1400 nm) to ultraviolet (e.g., 240-400 nm), although the invention is not limited to such ranges. The pulse length of the laser can be nanosecond (e.g., 1-1000 ns, or any value or range of values therein), picosecond (e.g., 5-1000 ps, or any value or range of values therein), or femtosecond (e.g., 5-5000 femtoseconds, or any value or range of values therein), although the invention is not limited to such pulse length ranges. In working examples using an IR laser (e.g., wavelength in the range of 800-1400 nm), when the pulse length is in the femtosecond range, the pulse frequency may be in the range of 10⁹-10¹⁴ Hz (or any value or range of values therein), and when the pulse length is in the nanosecond range, the pulse frequency may be in the range of 10⁵-10⁹ Hz, or any value or range of values therein. In any case, the laser power may be in the range of 10-1000 W, or any value or range of values therein. However, the invention is not limited to such ranges or values, and can be easily extended to other frequencies, pulse lengths, and wavelengths. One skilled in the art is capable of determining laser parameters that provide selectivity for removal of the cathode layer 120 relative to the first barrier 115a (or metal foil or sheet 110, in the absence of the first barrier 115a).

Referring to FIG. 3A, cathodes 122a-d for cells in different columns on the substrate 110/115a-b are shown. Substantially all of the cathode layer 120 between adjacent cathodes 122a-d is removed, but preferably, minimal material from the barrier 115a is removed. The patterned cathodes 122aa-dj (FIG. 3B) essentially define the active areas of an array of solid-state battery cells. The laser-patterned cathodes 122a-d and 122aa-dj may be conventionally cleaned (e.g., by rinsing with and/or submersing in deionized water, with or without applied ultrasound, spraying with a low-boiling point, water-miscible organic solvent such as acetone or isopropanol, and drying by heating in an oven at a temperature of 100-150 °C) prior to subsequent processing.

FIG. 4 shows a cross-section of the structure of FIG. 3A with an insulator 130a-c deposited into the spaces between the laser-patterned cathodes 122a-d. The insulator 130a-c can be blanket-deposited by chemical vapor deposition (CVD, for example plasma-enhanced chemical vapor deposition [PECVD]), sol-gel coating, extrusion coating, sputtering, etc., or can be selectively deposited (e.g., by screen printing, inkjet printing, etc.), followed by curing or annealing, if necessary or desired. In some embodiments (e.g., as shown in FIG. 4), the insulator 130a-c is deposited so that it partially fills the trenches between the cathodes 122a-d. Printing the insulator using a flowable ink may be particularly advantageous in such embodiments, as the ink can flow to the bottom of the trenches even when the pattern of ink being printed is not perfectly aligned with the trenches. In various embodiments, the insulator 130a-c has a thickness that is 20-90% of the thickness of the laser-patterned cathodes 122a-d, or any percentage or range of percentages therein (e.g., 25-50%). In the layout view (not shown), the pattern of cathodes 122aa-dj surrounded by the insulator 130a-d resembles that of the cathodes 122aa-dj on the first barrier 115a in FIG. 3B, but with slightly less area of the cathodes 122aa-dj exposed.

When the insulator 130a-c is blanket-deposited to a thickness less than that of the cathodes 122a-d, it is subsequently patterned photolithographically so that it remains in the space between cathodes 122a-d (or cathodes 122aa-dj in FIG. 3B). For example, photolithographic patterning may comprise coating a photoresist on the blanket-deposited insulator, irradiating selected portions of the photoresist, developing the photoresist to expose the portions of the insulator to be removed, removing the exposed portions of the insulator by etching, removing the remaining photoresist by ashing, and optionally cleaning the resulting structure shown in FIG. 3A. However, when the insulator 130a-c is blanket-deposited to a thickness greater than that of the cathodes 122a-d (i.e., so that it completely fills the spaces between cathodes 122a-d), it can subsequently be removed from outside the spaces between cathodes 122a-d by grinding or polishing (e.g., chemical mechanical polishing).

The insulator 130a-c may comprise an inorganic insulator, such as a silicon and/or aluminum oxide and/or nitride (e.g., SiO₂, a silicon oxynitride, an aluminum oxide, etc.) or an organic insulator (e.g., an electrically and optionally thermally insulating polymer such as a polyimide, polyethylene, polyvinylchloride, an organosiloxane polymer such as poly(dimethylsiloxane), an epoxy resin, etc.). In one example, the insulator 130a-c comprises an inkjet-printable epoxy resin that sets or cures upon irradiation with ultraviolet (UV) light, or gentle heating (e.g., to a temperature of 80-150 °C). The insulator 130a-c allows for a non-electrically conductive layer below subsequently-deposited battery layers that enables facile laser patterning of the subsequently-deposited battery layers in future steps. For example, the insulator 130a-c prevents potential damage to the to-be-formed solid-state electrolyte and the interface between the cathode 120 and the electrolyte from heat generated during laser patterning, allowing the to-be-formed ACC to be patterned by laser ablation.

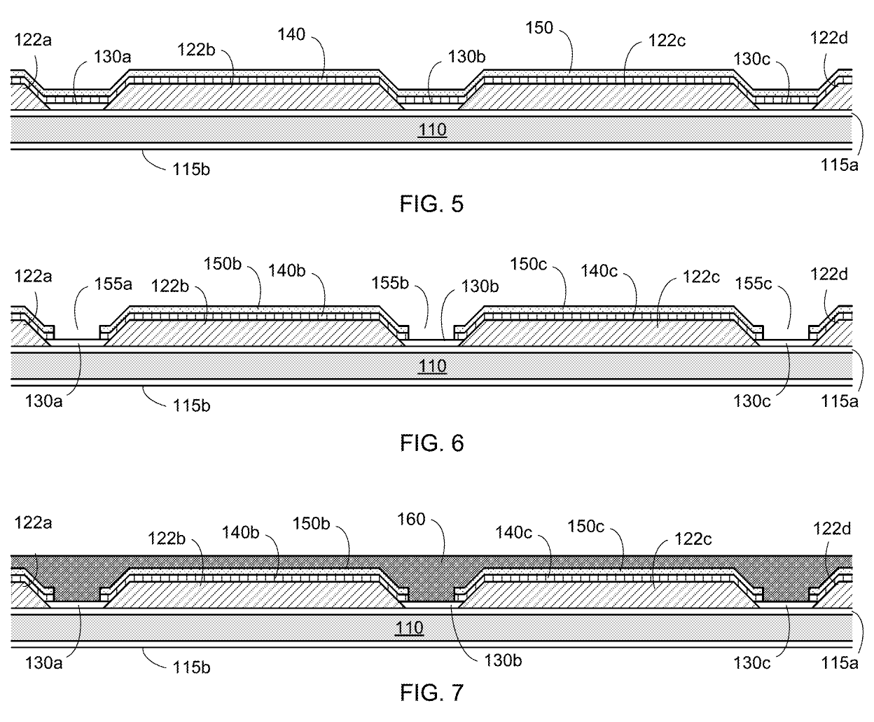

FIG. 5 shows a solid-state electrolyte layer 140 blanket-deposited on the cathode 120 and the insulator 130a-c, and an anode current collector (ACC) layer 150 blanket-deposited on the electrolyte 140. The electrolyte layer 140 may comprise or consist essentially of a conventional lithium phosphorus oxynitride (LiPON, which may optionally be carbon-doped) or Li₂WO₄, a good Li-ion conductor. Alternatively, the electrolyte layer 140 may comprise or consist essentially of one or more layers of a lithium lanthanum zirconium oxide (LLZO; e.g., Li₇La₃Zr₂O₁₂ in which some of the Zr may be substituted with one or more of niobium, tantalum, aluminum, gallium, indium, vanadium, antimony or hafnium) or other garnet-type oxide electrolyte. Further alternative electrolytes 140 may comprise or consist essentially of a NASICON (sodium superionic conductor), a sulfide-based inorganic electrolyte, a LISICON (lithium superionic conductor), or a solid inorganic-polymer composite electrolyte including one or more of the inorganic electrolytes mentioned herein.

The anode current collector layer 150 generally comprises a conductive metal, such as nickel, zinc, copper, tungsten, vanadium, alloys thereof (e.g., NiTi, NiV), etc., or another conductor, such as graphite. Preferably, the conductive metal for the anode current collector layer 150 is incapable of forming an alloy with lithium (e.g., a non-Li alloying metal or alloy). The anode current collector layer 150 can be deposited by spray coating or other blanket deposition technique (e.g., sputtering, evaporation, chemical vapor deposition [CVD] or atomic layer deposition [ALD]).

The electrolyte layer 140 may have a thickness of 0.1-5 µm, or any thickness or range of thicknesses therein (e.g., 0.2-2 µm), although it is not limited to this range. Independently, the anode current collector layer 150 may have a thickness of 0.1-5 µm, or any thickness or range of thicknesses therein (e.g., 0.2-2 µm), although it is also not limited to this range.

In some embodiments, the electrolyte layer 140 may further comprise optional cathode and/or anode interface layers (not shown), each of which may comprise a lithiated metal oxide (see, e.g., U.S. Pat. No. 11,735,791, the relevant portions of which are incorporated herein by reference). For example, a metal oxide (e.g., NbO₂, Al₂O₃, Li₄Ti₅O₁₂ or LiNbO₃) interlayer may be formed on the cathode 120 (and optionally on the insulator 130a-c) prior to deposition of the electrolyte layer 140 (e.g., to reduce interfacial stress, decrease interfacial resistance, or suppress formation of a space charge layer). Alternatively or additionally, an amorphous (e.g., elemental silicon) interlayer may be deposited on the electrolyte layer 140 prior to formation of the anode current collector layer 150 to inhibit reduction of the electrolyte 140. In some embodiments, thermal annealing can modify the interface(s) between the layers of the cell, which can significantly reduce charge transfer resistance.

Forming the electrolyte layer 140 may comprise depositing a LiPON layer or a tungsten oxide layer of the formula WO₃₊ₓ (0 ≤ x ≤ 1) by sputtering, optionally using pulsed DC power. When the electrolyte layer 140 comprises LiPON, it may be deposited by RF sputtering or ALD. The sputtering target may comprise a Li₃PO₄ or mixed graphite-Li₃PO₄ target, the latter of which may contain 1-15 wt% of graphite, when the electrolyte layer 140 comprises LiPON or carbon-doped LiPON, and a metallic/elemental tungsten target when the electrolyte layer 140 comprises a tungsten oxide. In the latter case, sputtering is performed in an oxygen or oxygen-containing atmosphere. The method of making the electrolyte layer 140 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 100). Thermal annealing may comprise heating at a temperature of 150-500 °C for a length of time of 5-240 minutes, or any temperature or length of time therein (e.g., 250-450 °C for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100 °C for at least 10 minutes (e.g., to transform it into Li₂WO₄).

An LLZO electrolyte layer 140 may be formed by depositing an LLZO sol-gel (e.g., by spic-coating, extrusion coating, dip-coating, drip-casting, etc.), then annealing at a temperature in the range of 500-800 °C, or any value or range of values therein for 1-60 minutes in an oxygen-containing gas such as clean dry air (CDA). Examples of such a process can be found in U.S. Prov. Pat. Appl. No. 63/750,738, filed January 28, 2025 (Atty. Docket No. IDR2024-01-PR), the relevant portions of which are incorporated herein by reference. The sol-gel method of forming the electrolyte layer 140 has the advantage of forming a solid-state electrolyte 140 with a planar or substantially planar uppermost surface (which is advantageous when the insulator 130a-c fills or substantially fills the trenches between the cathodes 120a-d / 120aa-dj).

A separately-formed anode is not necessary in solid-state lithium batteries, as a lithium anode can be formed between the electrolyte 140 and the anode current collectors formed from layer 150 during charging, if necessary. Optionally, however, a thin lithium anode can be deposited by evaporation onto the electrolyte layer 140 prior to formation of the anode current collector layer 150. Alternatively, a thin, amorphous elemental silicon seed layer may be blanket-deposited onto the electrolyte 140 prior to deposition of the ACC layer 150. The silicon seed layer may be deposited by chemical vapor deposition (CVD; e.g., from silane gas), atomic layer deposition (ALD), coating from a liquid-phase silane such as trisilane, tetrasilane, cyclopentasilane, etc. The silicon seed layer may have a thickness of from 20 to 500 Å or any thickness or range of thicknesses therein (e.g., 50-200 Å).

The battery cells may further include one or more additional interlayers that modify the interfaces between different functional layers. For example, a metal oxide (e.g., Nb₂O₅, Al₂O₃, Li₄Ti₅O₁₂ or LiNbO₃) interlayer may be formed on the cathodes 120a-c / 120aa-dj prior to deposition of the electrolyte layer 140 (e.g., to reduce interfacial stress, decrease interfacial resistance, or suppress formation of a space charge layer). Of course, the battery cell can be made in the reverse order (i.e., the anode current collector may be first formed on the substrate, then the remaining layers deposited in reverse order thereon).

FIG. 6 shows a cross-section of patterned electrolytes 140a-d and patterned anode current collectors (ACCs) 150a-d after laser patterning or laser ablation to form openings 155a-c between adjacent electrolytes 140a-d and ACCs 150a-d. In the layout view (not shown), the patterned ACCs 150a-d with substantially the same shape and similar length and width dimensions to cathodes 120aa-dj in FIG. 3B are seen, with the insulator 130a-c visible between the ACCs 150a-d. In various embodiments, the ACC layer 140 and the electrolyte layer 140 are laser-patterned using light having a wavelength of 240-1400 nm, a pulse length of 5 femtoseconds to 1000 ns, a pulse frequency of 10⁵-10¹⁴ Hz, and/or a power of 10-1000 W, or any value or range of values within these ranges, although the invention is not necessarily limited to these ranges. In fact, there is no real need to pattern the electrolyte layer 140, as there is no cathode 120 below its peripheral edges to conduct Li⁺ ions. However, at the laser power typically employed to ablate / pattern the ACC layer 150, the laser also ablates / patterns the underlying electrolyte layer 140, particularly at electrolyte layer thicknesses of about 1 μm or less.

The ablation pattern for the ACC layer 150 and the electrolyte layer 140 (to be removed) is similar to that for the cathode layer 120, except that the widths of the polylines may be greater or smaller than those for the cathode layer 120, and there is generally no benefit to the ACCs 150a-d and the electrolytes 140a-d having sloped sidewalls. However, the line widths of the openings 155a-c may still be in the range of 2-50 µm (or any width or range of widths therein, such as, e.g., 5-20 µm), depending on the laser beam spot size and energy profile, and the desired separation between adjacent ACCs and electrolytes for subsequent processing. Similar to the cathode layer 120, the polylines for patterning the ACC layer 150 and the electrolyte layer 140 may exclude sharp corners, and additional lines along the periphery of the blanket-deposited ACC layer 150 and electrolyte layer 140 sheet or roll may also be laser-patterned to ensure pull-back of the patterned ACCs 150a-d and electrolytes 140a-d from the edge of the substrate (e.g., sheet or roll) and/or to ensure that the patterned ACCs 150a-d and electrolytes 140a-d have a relatively linear and/or vertical sidewall along the edge of the substrate.

After laser patterning / ablation, debris removal or cleaning (if needed) may comprise dry etching (e.g., using an etch chemistry and conditions that are at least somewhat selective for removal of the ACC material relative to the electrolyte material), a line beam laser (e.g., having a relatively small or narrow beam width), a high-velocity gas jet (e.g., a stream of dry CO₂, nitrogen or air), or by wet chemical cleaning (e.g., using distilled, deionized water, followed by an organic solvent such as acetone or isopropyl alcohol), optionally in the presence of applied ultrasound.

Advantages of laser patterning and/or ablation of the electrolyte layer 140 and the anode current collector layer 150 include the following.

Patterning is dry, so there is no effect on the battery layers or their chemistry

The patterned edges of the electrolytes 140a-d and the ACCs 150a-d are relatively sharp

Patterning throughput is typically higher than photolithography due to the relatively high laser scan rate

Lower cost, due to the elimination of lithography or shadow masks

Patterning flexibility is maximized, as laser ablation flows and/or is driven by a graphical drawing, which is easy and fast to change relative to photolithography and shadow masking

The insulator between the cathodes 120a-d under the areas of the electrolyte layer 140 and the ACC layer 150 to be patterned reduces or effectively prevents thermal damage to the cathode/electrolyte interface

Elimination of an etching process to pattern the electrolyte layer 140 and the ACC layer 140 prevents Li⁺ transport to the electrolyte surface during patterning, which further prevents “dead” lithium formation and capacity loss

The electrolytes 140a-d and the anode current collectors 150aa-ch may have area dimensions (i.e., length and width dimensions) that are 75-98% of the corresponding length and width dimensions, respectively, of the cells and 80-110% of the corresponding length and width dimensions, respectively, of the. The pull-back distance of the ACCs 150aa-ch from the cell edges should be sufficient to electrically isolate the ACCs from the CCC / substrate 110. At this point, the battery cells are defined

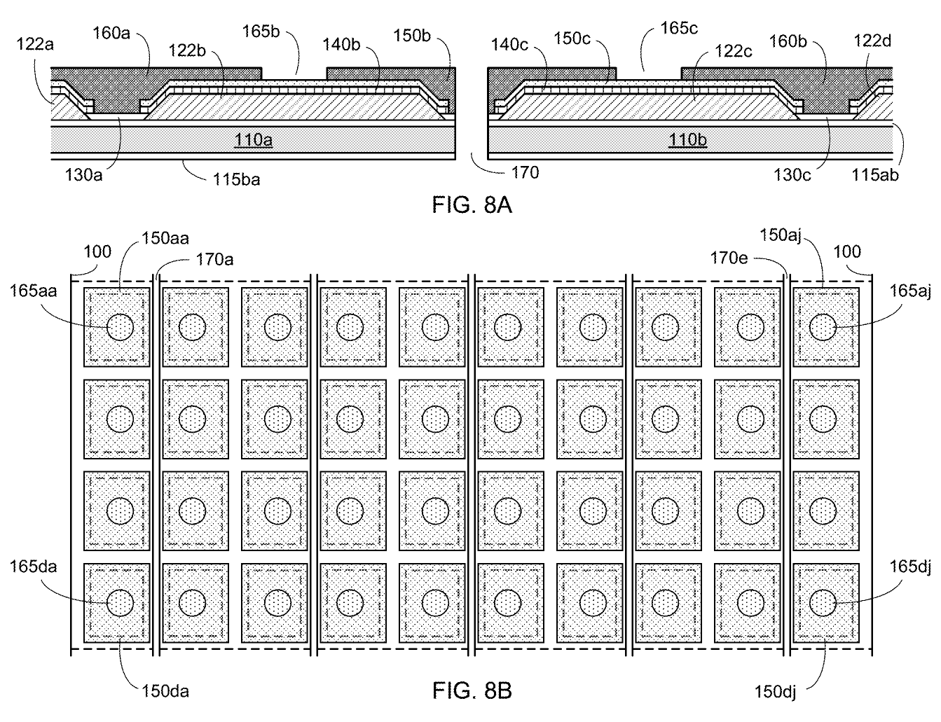

Referring now to FIG. 7, the cells are encapsulated with a mechanically compliant moisture barrier and electrically insulating encapsulant 160. The encapsulant 160 covers the front or uppermost surface of the cells (i.e., the ACCs 150a-d and the insulators 130a-c). The encapsulant 160 may be formed by blanket deposition or coating (e.g., spin-coating, dip-coating, extrusion coating, etc.), or it may be printed (e.g., by inkjet printing or screen printing) onto the cells. One advantage of printing to form the encapsulant 160 is that an opening 165a-d (see FIG. 8A; openings 165a and 165d are not shown) may be formed on each cell over the corresponding ACC 150 during printing, without any need for additional processing (such as laser ablation, photolithographic patterning, etc.) to form the openings.

The encapsulant 160 may comprise parylene, polyethylene, polypropylene, or another polyolefin, with or without a thin inorganic oxide overlayer such as SiO₂ (e.g., which may be formed by heating a tetraalkyl silicate such as tetraethyl orthosilicate [TEOS]). When printed, the material(s) of the encapsulant 160 may be dissolved or suspended in an appropriate solvent (e.g., one or more organic solvents, such as a C₆-C₁₀ alkane or cycloalkane, a C₁-C₆ halogenated alkane or cycloalkane including one or more halogen atoms and that is in the liquid phase at 25 °C and 1 atm pressure, a C₄-C₆ cyclic or acyclic ether, a C₄-C₁₀ cyclic or acyclic polyether, a C₁-C₁₀ cyclic or acyclic alkanol, a C₃-C₄ ketone, a C₆-C₁₀ arene substituted with 1-3 C₁-C₄ alkyl groups, ) prior to printing. In certain embodiments, after printing or deposition, the material for the encapsulant 160 may be cured (e.g., by irradiation with ultraviolet light) to provide certain desirable properties (e.g., a certain minimum hardness, optical property, adhesion, etc.).

Referring to FIGS. 8A-B, if not already formed (e.g., by printing the encapsulant 160), openings 165a-d (FIG. 8A) or 165aa-dj (FIG. 8B) are formed in the encapsulant 160, exposing the underlying ACCs 140a-d / 140aa-dj. When the encapsulant 160 is blanket-deposited, the openings 165a-d / 165aa-dj may be formed by photolithographic patterning, as described herein. The openings 165a-d / 165aa-dj may have length and width dimensions that are 25-75% of the length and width of the underlying ACC 150a-d / 150aa-dj, or any percentage or range of percentages therein, but the invention is not limited to this range of percentages. Alternatively or additionally, the openings 165a-d / 165aa-dj may have an area that is 5-50% of the area of the underlying ACC 150a-d / 150aa-dj, or any percentage or range of percentages therein. In the layout view (FIG. 8B), the openings 165a-d / 165aa-dj may have a circular shape, or another regular or irregular shape (e.g., square or rectangular [with or without rounded corners], oval, hexagonal, octagonal, an X or + shape, etc.).

The substrate 100 may then be attached to a substrate support or holder (not shown), and the encapsulant 160, the insulator 130 and the substrate 100 (i.e., the metal foil sheet or roll 110 and barriers 115a-b) are cut or diced along the “ACC edges” of the battery cells to form an opening 170 every other cell, or every other row or column of cells (when the cells are in an array or on a multi-column roll; see, e.g., cuts 170a-e in FIG. 8B). As shown in FIG. 8B, the cuts 170a-e may be made in the lanes between the first and second rows or columns, the next-to-last and last rows or columns, and every other lane therebetween, and such that the substrate is divided or separated into strips of cell pairs (e.g., containing ACCs 150ab-ac, 150bb-bc, 150cb-cc and 150db-dc) and two single rows or columns of cells (e.g., the outermost rows or columns). When the substrate support is a tape or sheet, it is generally a UV release tape or sheet, containing an adhesive on one or both major surfaces that loses its adhesive properties upon sufficient irradiation with ultraviolet (UV) light. The tape or sheet may be on a ring or other frame, configured to mechanically support the tape or sheet and allow some tension therein and some light to pass through the underside of the tape or sheet. When the substrate support is a substrate holder (e.g., for cutting or dicing by stamping), it may comprise a magnetic plate or chuck.

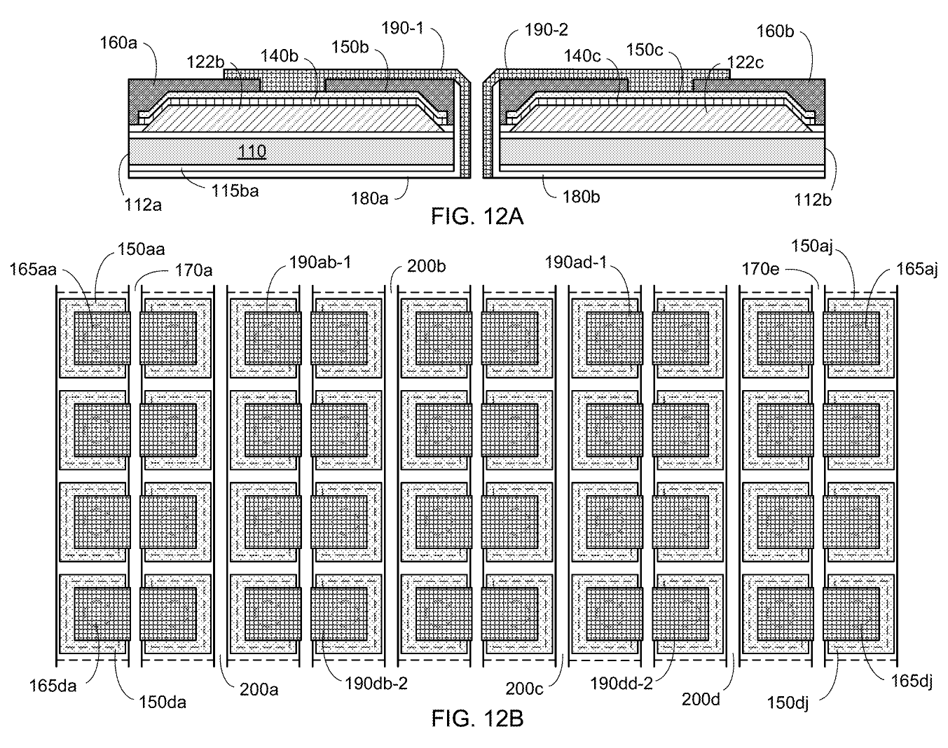

The openings 170a-e may be formed by laser (e.g., laser ablation), mechanical dicing or stamping, for example. When the cells are in an array or on a multi-column roll or sheet, they may also be cut or diced along the x-direction in FIG. 8B between adjacent cells (e.g., every row, between cells containing ACCs 150aa-ah and cells containing ACCs 150ba-bh, and between cells containing ACCs 150ba-bh and cells containing ACCs 150ca-ch, etc.) to form isolated cell pairs. The sidewalls along the openings 170a-e fully expose the entire cell stack, including the CCC / substrate 110. In a further option, the entire cell stack may be cut or diced between every column of cells, resulting in “CCC edges” (see, e.g., FIGS. 12A-B).

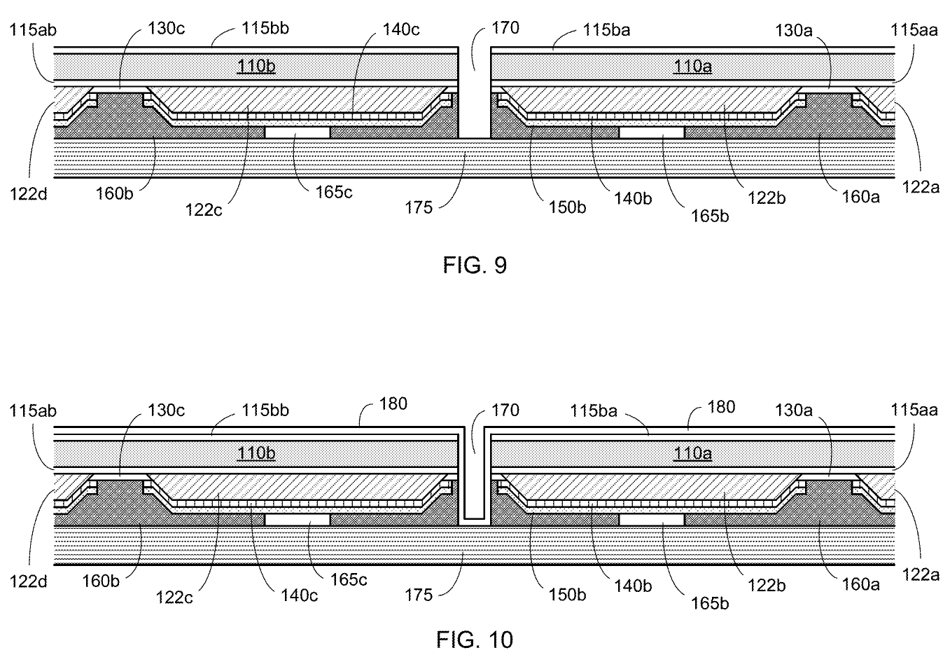

However, when the substrate 100 is cut or diced every other cell, or every other row or column of cells to form openings 170a-e exposing the ACC edges or sidewalls of the battery cells, the ACC edges or sidewalls are then insulated to isolate the CCC / metal sheet or roll 110. FIG. 9 shows the initially separated cell pair strips of FIG. 8B, flipped upside down and attached to an adhesive / mechanical support 175 (such as a UV tape) through the encapsulant 160a-b.

FIG. 10 is a cross-sectional view of the cell pair strips on the adhesive / mechanical support 180 of FIG. 9, with an insulator layer 180 blanket-deposited on the backside of the substrate 100 (i.e., the outer surface of the second barrier 115b) and along the ACC sidewalls of the cells in the openings 170. The insulator layer 180 may comprise an electrically insulating material, such as a silicon and/or aluminum oxide and/or nitride, or an organic (e.g., polymeric) insulator as described herein. The insulator layer 180 may be blanket-deposited by CVD (e.g., PECVD), ALD, or sputtering. Advantageously, the opening 170 largely remains after deposition of the insulator layer 180, which may have a thickness of 0.2-2 μm.

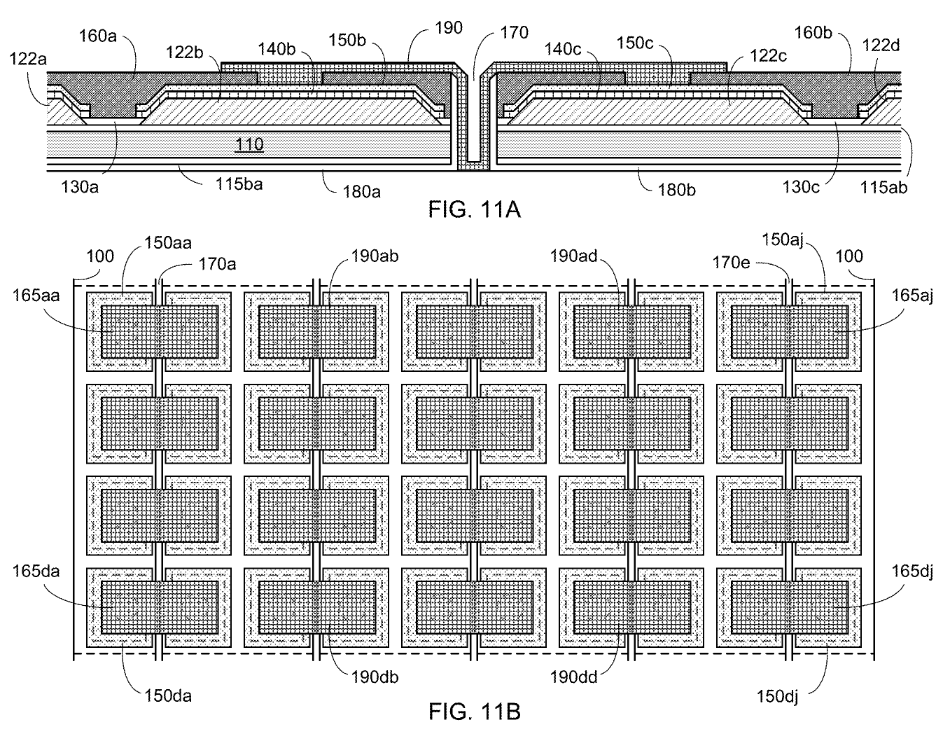

The cell pair strips and outermost single cell strips (see, e.g., FIG. 8B) with the insulator layer 180 thereon are transferred to another adhesive / mechanical support (such as another UV tape) so that the insulator layer 180 contacts the other adhesive / mechanical support, and a redistribution layer is then formed in the openings 165a-d in the encapsulants 160a-b and along the ACC sidewalls of the cells. FIG. 11A shows formation of an exemplary metal redistribution layer 190 along the ACC sidewalls of the cells (i.e., in the opening 170) and in the openings 165a-d in the encapsulants 160a-b to connect the ACCs 150a-d to a subsequently formed external battery terminal. FIG. 11B is a layout view showing the cell pair strips and outermost single cell strips of FIG. 8B with redistribution layers 190aa-de thereon, across the openings 170a-e.

The redistribution layer 190 may comprise Cu, Ni, Al, V, or another suitable and/or stable (e.g., air- and/or water-stable, and/or lithium-compatible) metal, and may be formed by sputtering, ALD or thermal evaporation (e.g., through a mask that exposes a region of the cell corresponding to the pattern of the redistribution layers 190aa-d3 [FIG. 11B], followed by removal of the mask), by blanket deposition, followed by photolithographic patterning and etching (as described herein), or by selective deposition, such as inkjet printing, aerosol-jet printing or screen printing. Printing may comprise use of a conventional metal-containing ink or paste. In some embodiments, the length and width dimensions of the redistribution layer 190 (FIG. 11A) or layers 190aa-de (FIG. 11B) may be on the scale of hundreds of microns (e.g., 200-1000 μm) or several millimeters (e.g., 1-10 mm), thereby enabling selective deposition processes such as inkjet printing, screen printing and shadow masking.

Low electrical resistance and a low curing temperature is desirable for the redistribution layers 190, and the redistribution layers 190 have a thickness typically in the range 0.25-2 µm on the uppermost surface of the cells (i.e., on the encapsulant 160). Due to liquid flow during printing, the entireties of the openings 165b-c / 165aa-dj may be filled with metal, which may be beneficial during battery cycling.

A single redistribution layer 190 is on the ACC sidewalls of adjacent cells (i.e., across the openings / gaps 170). Referring now to FIGS. 11A and 12A, the redistribution layers (or ACC redistribution traces) 190 conduct charge carriers between the ACCs 150 (exposed through the vias or openings 165 in the barrier / insulation layers 160) to the ACC sidewalls, in the opposite direction from the CCC contacts 112a-b (FIG. 12A).

Referring now to FIG. 12A, the ACC redistribution traces 190 electrically contact the ACCs 150a-d through the insulation layer openings 165, but are physically and electrically insulated from the CCCs / substrates 110a-b by the insulator layers 180a-b in the openings 170. One advantage of forming the insulator layer 180 in the manner shown in FIG. 10 is that, after transfer of the cells to the other adhesive / mechanical support or other process separating the cell pair strips and single-cell strips from each other, the bridge in the insulator layer 180 at the bottom of the openings 170 may break along lines of relatively high stress (e.g., from corner to corner), resulting in a sloped and/or curved corner of the cell, reducing stress in the redistribution layer 190 and the occurrence of unusual electrical fields being generated from or in the redistribution layer 190 during use of the battery. When the ACC redistribution traces 190 are a metal, they form an intrinsic barrier to ambient ingress in the region of the vias or openings 165. The ACC redistribution traces 190 are both physically on the top surface of the cell and covering at least part of the cell sidewalls. The ACC redistribution traces on the sidewalls (e.g., 172a-b in FIG. 13A) enable electrical connection of the cells to a terminal on a side or exterior surface of the packaged battery at a later stage of the method.

In further embodiments involving printing the encapsulant 160a-b and the redistribution layer, prior to printing either layer, the method may further comprise testing the cells to determine battery functionality (e.g., charging, charge holding, and/or discharging properties). Cells that fail testing (i.e., that are identified as non-functional or insufficiently functional) may have the encapsulant 160 and/or the redistribution layer 190 printed differently. For example, if the cells are tested prior to printing the encapsulant 160, the via / opening 165 in the encapsulant 160 can be omitted in those cells that fail testing. In other words, when a cell fails testing (i.e., is identified as defective) prior to printing the encapsulant 160, the encapsulant 160 may completely cover the ACC layer 150 in the defective cell. Similarly, when a cell fails testing prior to printing the redistribution layer 190, the redistribution layer 190 may be omitted (i.e., not printed) in those defective cells.

FIGS. 12A-B show singulated cell strips, exposing CCC contact surfaces 112a-b of the metal foil strips 110a and 110b (FIG. 12A). Prior to singulation (dicing), the cell pairs may be placed on a substrate holder (e.g., a magnetic plate or chuck) or an epoxy-coated tape (not shown). In this case, dicing along the CCC edges or sidewalls to form openings 200a-d (FIG. 12B) creates the single cell strips and exposes the CCC contact surfaces 112a-b. Alternatively, dicing along the CCC sidewalls can be performed at the same time as dicing along the ACC sidewalls (FIGS. 10A-B), in which case the insulator layers 180a-b and the redistribution layer 190 should be printed (to avoid depositing the insulator layers 180a-b and the redistribution layer 190 on the CCC sidewalls). The epoxy coating on the tape may be used to keep the individual (i.e., further singulated) cells together during stacking, and may provide a passivation/sealing layer on one side or surface of the stacked cells during packaging. Thus, the coated tape may comprise a die attach film (DAF). Alternatively, an adhesive (e.g., an epoxy adhesive) may be coated or printed onto the upper or lower surface of the battery cells prior to stacking.

Singulation, both of the single-cell strips shown in FIGS. 12A-B and of the individual cells from the single-cell strips, may be conducted by laser dicing, mechanical dicing or stamping. To ensure exposure of the CCC contact surface in the outermost single-cell strips, as well as to ensure uniform sizing (i.e., length and/or width) of the cells, the outermost edges of the single-cell strips (identified by the number “100” in FIG. 8B) can be polished or ground, prior to singulation and/or stacking. When present, the epoxy coating and the tape may also be cut during singulation. The redistribution layer 190 (FIG. 12A) may be cut or separated to form redistribution layers 190-1 and 190-2 either during singulation or during removal (e.g., from a chuck or other deposition / patterning apparatus) at or near the end of the redistribution layer formation process.

Both the single-cell strips and the individual singulated cells may be stacked to form a multi-cell stack, with the CCC (substrate) edges 112 along one side of the stack, and the redistribution layers 190 along the opposite side. An adhesive layer (not shown) between cells in the stack can be from the coated tape or from a liquid die attach (DA) or printing process, and can be applied to the back and/or front major surface of the cells (e.g., every other cell), prior to or after cell or cell strip singulation. If not applied as part of a DA process, the adhesive can be applied by methods such as b-stage laminated film formation, dispensing, jetting, inkjet printing, screen printing, etc. The parallel cells in multi-cell stack each additively contributes to the overall battery capacity. Cell stacking (e.g., by pick-and-place techniques or folding) may be conducted as disclosed in U.S. Pat. No. 12,132,166 and U.S. Pat. Appl. Nos. 18/319,532, 18/319,552, 18/640,416, 18/885,525, 18/925,267, 18/925,892 and 18/946,887, filed May 18, 2023, May 18, 2023, April 19, 2024, September 13, 2024, October 24, 2024, October 24, 2024 and November 13, 2024, respectively (Attorney Docket Nos. IDR2022-02, IDR2022-03, IDR2022-06, IDR2022-07, IDR2022-08, IDR2022-09 and IDR2022-10), the relevant portions of which are incorporated herein by reference. A dummy cell (e.g., an encapsulated metal foil substrate similar or identical to the metal foil, sheet or film 110 or the barrier-covered metal foil, sheet or roll 110/115) may be placed on top of the stack (e.g., of individually singulated cells) as a moisture and air barrier and to protect the stack from externally-caused damage. Optionally, markings on one major surface of the dummy cell can be used as external product markings.

Battery terminal dipping and plating on the stacked set of cells forms external electrical contacts, as disclosed in U.S. Pat. Appl. Nos. 18/319,532, 18/319,552, 18/640,416, 18/885,525, 18/925,267, 18/925,892 and 18/946,887, cited above (the relevant portions of which are incorporated herein by reference). End terminals at the CCC and ACC edges (e.g., the exposed CCC surfaces 112 and the redistribution layers 190, respectively) are dipped into or coated with a conductive epoxy to electrically gang the terminals and form the CCC and ACC terminals of the packaged battery. The conductive epoxy may comprise an Ag-filled or Ni-filled conductive epoxy paste. Alternatively, a pin-to-pin paste transfer method may be used, or a stable and/or noble metal such as Au, Pt, Pd or Cu can be used in place of the Ag or Ni. Plating a metal onto part or all of the CCC and ACC terminals creates a solderable surface for PCB attachment by the end user. For solderable termination, the epoxy surface may be plated with Ni, Ag, In, Sn, or a combination thereof (e.g., Ni, then with In or Sn). The conductive epoxy may contain a relatively high metal content, which can retard ambient ingress of oxygen or water vapor. Plating the epoxy with one or more pure metal layers may further block such ambient ingress. Both of these features help with ambient air resistance, particularly on the CCC sidewall, due to the CCC sidewall being uncovered after cell singulation to form the single cell strips (FIGS. 12A-B).

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A method of making solid-state battery cells, comprising:
laser-patterning a cathode layer on a substrate to form a cathode for each of a plurality of solid-state battery cells,
forming an insulator between cathodes in adjacent cells, exposing an uppermost surface of the cathode in each solid-state battery cell,
blanket-depositing a solid-state electrolyte layer on the cathodes and the insulator, wherein the solid-state electrolyte layer contacts the exposed uppermost surface of the cathode in each solid-state battery cell,
blanket-depositing an anode current collector (ACC) layer on the solid-state electrolyte layer, and
patterning the ACC layer and the solid-state electrolyte layer to form an electrolyte and an ACC in each of the solid-state battery cells.

2. The method of claim 1, wherein laser patterning the cathode layer provides the cathodes with sloped sidewalls having an angle of 5-75° relative to the plane of the substrate.

3. The method of claim 1, wherein the cathode layer is laser-patterned using a programmable laser patterning device, the method further comprises programming a programmable laser patterning device to form polylines in the cathode layer, and the polylines comprise a first plurality of parallel lines along a first direction and a second plurality of parallel lines along a second direction orthogonal to the first direction.

4. The method of claim 1, wherein the insulator is formed by (i) selective deposition or (ii) blanket-deposition and photolithographic patterning or polishing.

5. The method of claim 1, wherein the insulator comprises a silicon oxide or a heat-tolerant organic polymer.

6. The method of claim 1, wherein the ACC layer and the electrolyte layer are patterned substantially simultaneously by laser patterning or laser ablation using a programmable laser patterning device.

7. The method of claim 1, further comprising encapsulating the solid-state battery cells with an encapsulant, forming a via or opening in the encapsulant in each of the solid-state battery cells to expose the ACC, cutting or dicing the cells through the encapsulant, the insulator and the substrate to expose an ACC edge or sidewall of the solid-state battery cells, forming an insulator layer along the ACC edge or sidewall, and forming a redistribution layer in or over the via or opening and on the insulator layer along the ACC edge or sidewall.

8. The method of claim 7, wherein the redistribution layer comprises an elemental metal or an alloy consisting essentially of elemental metals, has a thickness of 0.25-2.0 μm, and is formed by (i) sputtering, atomic layer deposition (ALD) or thermal evaporation, followed by photolithographic patterning and etching, or (ii) selective deposition.

9. The method of claim 7, wherein the substrate comprises a metal foil that functions as a cathode current collector in each of the solid-state battery cells.

10. The method of claim 9, further comprising singulating the solid-state battery cells by cutting or dicing through the encapsulant, the insulator and the substrate to form a cathode current collector (CCC) contact in each of the solid-state battery cells, and packaging the singulated battery cells to form a solid-state battery.

11. The method of claim 10, further comprising, prior to packaging, stacking the singulated battery cells so that the ACC edges or sidewalls are on a first side of the stacked battery cells, and the CCC contacts are on an opposite side of the stacked battery cells.

12. The method of claim 9, wherein the metal foil comprises elemental aluminum, copper, titanium, nickel, iron, or an alloy thereof, and has a thickness of 10-100 μm.

13. The method of claim 1, wherein the cathode layer comprises a lithium metal oxide or lithium metal phosphate.

14. The method of claim 1, further comprising blanket-depositing a cathode material onto the substrate by laser deposition, sputtering, chemical vapor deposition (CVD), sol-gel processing, screen printing, inkjet printing, spray coating, or extrusion coating to form the cathode layer.

15. The method of claim 1, wherein the substrate comprises a metal foil, and the method further comprises forming a diffusion barrier on one or both major surfaces of the metal foil, then forming the cathode layer on the diffusion barrier.

16. The method of claim 1, wherein the solid-state electrolyte comprises lithium phosphorus oxynitride (LiPON), carbon-doped LiPON, Li₂WO₄ or one or more layers of a lithium lanthanum zirconium oxide (LLZO), in which some of the Zr may be substituted with one or more of niobium, tantalum, aluminum, gallium, indium, vanadium, antimony or hafnium.

17. The method of claim 16, wherein blanket-depositing the solid-state electrolyte comprises depositing a LiPON layer or a tungsten oxide layer of the formula WO₃₊ₓ (0 ≤ x ≤ 1) by sputtering or atomic layer deposition (ALD), or depositing one or more LLZO layers by a sol-gel technique.

18. The method of claim 1, wherein the ACC layer comprises graphite or a conductive metal incapable of forming an alloy with lithium, has a thickness of 0.1-5 µm, and is blanket-deposited by spray coating, sputtering, evaporation, CVD or ALD.

19. A solid-state battery cell, comprising:
a substrate,
a cathode having sidewalls at an angle of 5-75° with respect to the substrate,
an insulator surrounding a base of the cathode,
a solid-state electrolyte on the cathode,
an anode current collector (ACC) on the solid-state electrolyte, wherein the electrolyte and the ACC are co-extensive,
an encapsulant on the ACC and the insulator,
an insulator layer along an ACC sidewall of the battery cell, and
a redistribution layer on the encapsulant and the insulator layer, in electrical contact with the ACC, wherein:
sidewalls of the electrolyte and the ACC are separated from the cathode by the insulator.

20. The solid-state battery cell of claim 19, further comprising a cathode current collector (CCC) having a CCC contact, wherein the insulator and the encapsulant are along an outermost periphery of the solid-state battery cell above the CCC contact.
